(19) United States
(12) Patent Application Publication
(10) Pub. No.: US 2026/0227094 A1
(43) Pub. Date: Aug. 6, 2026

(54) ELECTRIC HEATER FOR VEHICLE

(71) Applicant: I.R.C.A. S.P.A. INDUSTRIA RESISTENZE CORAZZATE E AFFINI, Vittorio Veneto (IT)

(72) Inventors: Michele BENVENUTO, Treviso (IT); Roberta COLLOT, Conegilano (IT); Andrea DEL TOS, Vittorio Veneto (IT); Federico ZOPPAS, Treviso (IT)

(21) Appl. No.: 19/149,545

(22) PCT Filed: Jan. 24, 2024
(86) PCT No.: PCT/IB2024/050672

§ 371 Date: Jul. 20, 2025

(30) Foreign Application Priority Data
Jan. 24, 2023 (IT) 102023000000993

(51) Int. Cl. F24H 1/14; B60H 1/22; F24H 9/20

(52) U.S. Cl. CPC F24H 1/14; B60H 1/22; F24H 9/20

(57) ABSTRACT

An electric heater (1) for a vehicle, adapted to heat a liquid crossing said heater, comprising
a body (2) made of die-cast metal material;
at least one electrical resistor (3) in contact with said body;
an inlet section (10) and an outlet section (11) for the liquid;
a first flow path (4) for the liquid, from the inlet section to the outlet section, made on a first face of said body;
a first cover (6) which closes with a first side thereof the first flow path;
an electronic control unit (8) arranged on a second side of said first cover, opposite the first side;
   wherein the first flow path (4) comprises a plurality of channels (21), delimited by bulkheads (9) projecting from the first face of the body, which branch off from the inlet section and flow into the outlet section;
   wherein said electronic control unit (8) comprises at least one electronic switch (22) arranged in a distal position both from said inlet section and from said outlet section;
   and wherein at least one longitudinal fin (40) is provided, projecting from the first side of said first cover (6) at said at least one electronic switch (22) and inserted into a corresponding longitudinal recess (41) or longitudinal interruption of at least one bulkhead (9) so that the longitudinal flanks of said at least one longitudinal fin (40) define part of a side wall of two adjacent channels.

### FIELD OF THE INVENTION

The present invention relates to an electric heater for vehicles, preferably but not necessarily electric or hybrid vehicles, in particular to heat a battery cooling liquid, in case of low outdoor temperatures, keeping the ideal operating temperature constant, or to heat a liquid for use in an exchanger for heating the air in the passenger compartment.

### BACKGROUND ART

The battery is essential for the operation of an electric or hybrid vehicle. It must provide the amount of energy necessary to drive the vehicle quickly and reliably. Most batteries are high-voltage hybrid lithium-ion and nickel-metal batteries.

It is essential that the batteries used are operated within a determined temperature range. In fact, the service life starts reducing from an operating temperature of +40° C., while performance and power decrease below −10° C. Further, the temperature difference between the individual battery cells must not exceed a certain value. Exceeding the limit temperatures results in more rapid aging and therefore the corresponding early failure of the battery. Vehicle manufacturers aim for a battery life equal to that of the vehicle. Therefore, the aging process can only be counteracted by optimally managing the temperature.

The battery unit includes battery cells, a cooling plate and an auxiliary electric heater. The cooling plate, mounted in the battery cell block, is crossed by the coolant composed, for example, of water and glycol.

To ensure higher performance and maximum service life of the battery, the temperature of the relative coolant must be comprised between approximately 15 and 30° C. When temperatures are too high, the liquid is cooled, for example, by a low-temperature radiator. If, on the contrary, the temperatures are too low, the coolant is heated by the auxiliary electric heater. The latter thus guarantees sufficient control of the battery temperature at low outdoor temperatures.

To carry out this heating, the battery is integrated into a secondary circuit. This circuit guarantees constant maintenance of the ideal operating temperature, between 15° and 30° C. Such an electric heater generally comprises at least one electric heating unit for generating heat and for discharging the generated heat to a heat transport medium, represented by the aforementioned liquid, by means of a body made of metal material with which the electric heating unit is in contact.

Such liquid can be, for example, water, glycol, water and glycol, or another suitable heat-transporting liquid.

This liquid flows along a flow path comprising at least one channel arranged on one face of said metal body and closed by a cover fastened onto said metal body. Said at least one channel communicates directly at its ends with the inlet section and the outlet section of the heater.

The electric heater must be compact and is generally shaped as a rectangular parallelepiped. The diameter of the inlet and outlet ports or pipe connections is defined by the section of the hydraulic circuit pipes.

The electric heating unit includes a heating element, for example a tubular resistor immersed in the thickness of the metal body or a film resistance deposited on a surface of said metal body which is not in contact with the liquid.

The electric heating unit is connected to an electronic control unit that allows the thermal power of the heating unit to be controlled.

The electronic control unit can, for example, comprise at least one electronic switch, such as a power transistor or other semiconductor power device, for example for controlling an electric current in the heating unit or for controlling a voltage applied to the heating unit. The power transistor can for example be an insulated gate bipolar transistor (IGBT). The power transistor can be electrically connected in series with the heating element. As a side effect, the electronic control unit typically generates heat that must be dissipated to prevent the control unit from overheating.

In particular, electronic switches dissipate parasitic power which must be removed to avoid damage thereto.

In some known solutions, the electronic switches are arranged in thermal contact with one side of the cover which closes, with its further opposite side, the at least one channel of the flow path, said cover in turn exchanging this heat with the liquid flowing along said path.

In other known solutions, the electronic switches are positioned at the inlet section of the heater, which is unheated and arranged upstream of the effective heating area, so as to dissipate the heat generated by the electronic control unit by means of the liquid entering from the inlet port.

Further, to improve the heat exchange between the electronic switches and the liquid, some known solutions involve the addition of turbulators, at the electronic switches, on the side of the cover in contact with the liquid. Disadvantageously, these turbulators increase pressure losses as they hinder the flow of the liquid in the inlet section.

A further disadvantage of these other solutions is represented by the fact that, if the manufacturer mounted the heater in such a way as to reverse the direction of the flow of liquid between the inlet and outlet, the electronic switches would no longer be adequately cooled because they would be located at the outlet section where the liquid would be too hot. Thus, there is a need to provide an innovative electric heater to solve the aforementioned drawbacks.

### SUMMARY OF THE INVENTION

An object of the present invention is to provide an electric heater for vehicles that allows the heat generated by the electronic control unit to be dissipated, avoiding the overheating thereof, in a more efficient way by limiting pressure losses as much as possible.

Another object of the present invention is to provide an electric heater that allows the inlet and outlet pipe connections or ports of the heater to be arbitrarily connected to the relevant hydraulic circuit, while still ensuring good cooling of the electronic control unit.

A further object of the present invention is to provide an electric heater that allows better performance, simultaneously guaranteeing a greater heat exchange surface, low pressure losses, high thermal power and reduced dimensions.

The present invention achieves at least one of these objects, and other objects which will be evident in light of the present description, by means of an electric heater for a vehicle, adapted to heat a liquid passing through said heater, comprising
a body made of die-cast metal material;
at least one electrical resistor in contact with said body;
an inlet section and an outlet section for the liquid;
a first flow path for the liquid, from the inlet section to the outlet section, made on a first face of said body;
a first cover which closes with a first side thereof the first flow path;
an electronic control unit arranged on a second side of said first cover, opposite the first side;
   wherein the first flow path comprises a plurality of channels which branch off from the inlet section and flow into the outlet section, and which are delimited by bulkheads projecting from the first face of the body;
   wherein said electronic control unit comprises at least one electronic switch;
   wherein at least one longitudinal fin is provided, projecting from the first side of said first cover at said at least one electronic switch and inserted into a corresponding longitudinal recess or longitudinal interruption of a respective bulkhead, and wherein the longitudinal flanks of said at least one longitudinal fin define part of a side wall of two adjacent channels of said plurality of channels.

Advantageously, in the heater of the invention said at least one longitudinal fin of the cover, arranged at at least one electronic switch, is configured to locally replace a portion of bulkhead delimiting two adjacent channels of the flow path of the liquid. Therefore, the electronic switch is adequately cooled as the heat exchange surface below said switch increases, but the pressure losses do not increase because the flow of liquid is substantially unaltered, in particular with respect to the flow of the liquid flowing in the channels where no longitudinal recess or longitudinal interruption in the bulkheads is provided.

In a preferred variant, the at least one electronic switch is advantageously arranged in a distal position both from said inlet section and from said outlet section, with the advantage that the direction of the flow can be reversed without compromising the heat dispersion of the electronic control unit, which is cooled by a liquid that is at an intermediate compromise temperature between inlet and outlet.

Further features and advantages of the invention will become more apparent in the light of the detailed description of exemplary but not exclusive embodiments.

The dependent claims describe particular embodiments of the invention.

### BRIEF DESCRIPTION OF THE FIGURES

The description of the invention refers to the accompanying drawings, which are provided by way of non-limiting example, in which:

FIG. 1 shows a perspective view of an electric heater according to the invention;

FIG. 2 shows a cross-section of the electric heater in FIG. 1;

FIG. 3 shows a view of a face of the heat exchanger body made of die-cast metal material in a first embodiment of the invention;

FIG. 4 shows a view of a face of the heat exchanger body made of die-cast metal material in a second embodiment of the invention;

FIG. 5 shows a view of a face of the heat exchanger body made of die-cast metal material in a third embodiment of the invention;

FIG. 6 shows a view of a face of the heat exchanger body made of die-cast metal material in a fourth embodiment of the invention;

FIG. 7 shows a sectional view, along a first median plane, of the heater of the invention with a first electrical resistor variant;

FIG. 8 shows a sectional view, along a first median plane, of the heater of the invention with a second electrical resistor variant;

FIG. 9 shows an enlargement of a sectional view of part of a flow path of the heater of the invention;

FIG. 10a shows an enlargement of a further sectional view of two flow paths of an embodiment of the heater of the invention, such as those illustrated in FIGS. 3-6;

FIG. 10b shows an enlargement of a further sectional view of the individual flow path of a further embodiment of the heater of the invention;

FIG. 11 shows a perspective view of a component of the heater of the invention;

FIG. 12 shows a sectional view of some components of the heater of the invention;

FIG. 13 shows an exemplary view of the position of some components of the heater of the invention;

FIG. 14 shows a first sectional view of some details of the heater of the invention;

FIG. 15 shows a second sectional view of said details of the heater of the invention;

FIG. 16 shows a first variant of a component of the heater;

FIG. 17 shows a second variant of the component of FIG. 16.

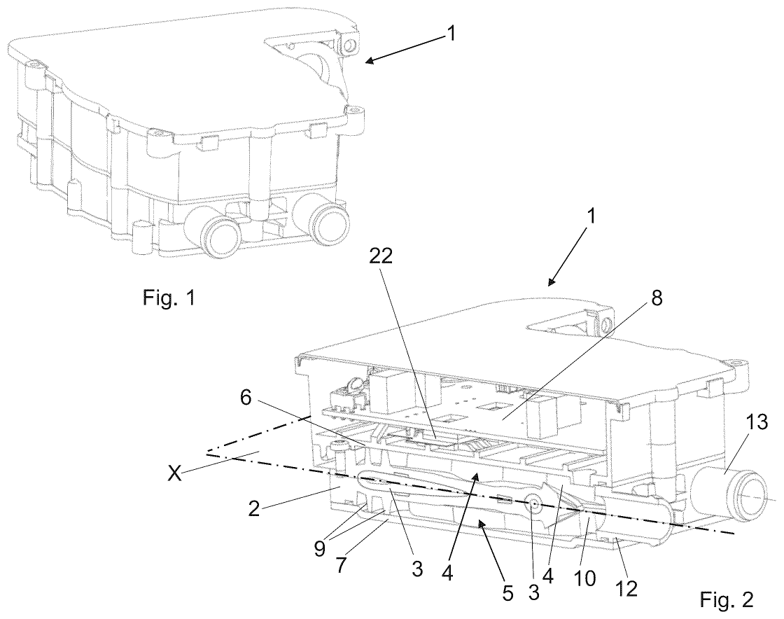

The same reference numerals and letters in the drawings identify the same elements or components.

### DESCRIPTION OF EXAMPLE EMBODIMENTS OF THE INVENTION

With reference to the Figures, some examples of an electric heater for vehicles, in particular electric or hybrid vehicles, are illustrated.

This electric heater can be used, in particular, to heat a battery cooling liquid of an electric or hybrid vehicle, in case of low outdoor temperatures, keeping the ideal operating temperature constant, or to heat a liquid for use in an exchanger for heating the air in the passenger compartment.

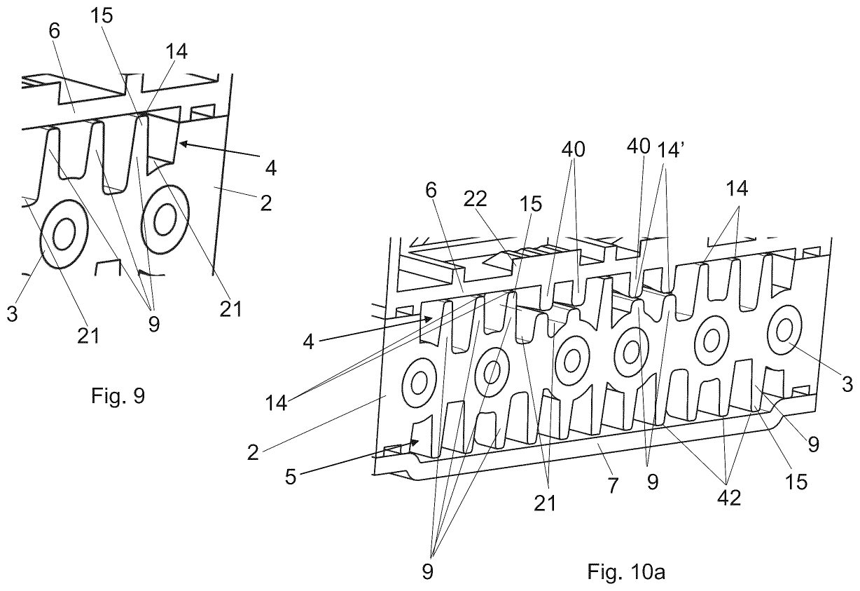

In all the embodiments of the invention, the electric heater comprises:
a body 2 made of die-cast metal material, preferably a single body 2 as shown for example in FIGS. 2-10b;
at least one electrical resistor 3, 32, 33 in contact with the body 2;
an inlet section 10 and an outlet section 11 for the liquid;
a first flow path 4 for the liquid, from the inlet section 10 to the outlet section 11, made on a first face of the body 2;
a first cover 6 that closes with a first side thereof the first flow path 4;
an electronic control unit 8 arranged on a second side of said first cover 6, opposite the first side, and comprising at least one electronic switch 22.

The first flow path 4 comprises a plurality of channels 21, substantially parallel to one another, which branch off from the inlet section 10 and flow into the outlet section 11. The channels 21 are delimited by bulkheads 9 projecting from the first face of the body 2. Such bulkheads 9, and thus the channels 21, can be made by mechanically processing the first face of the body 2 or be directly made by die-casting, producing a hollow area from which the bulkheads project.

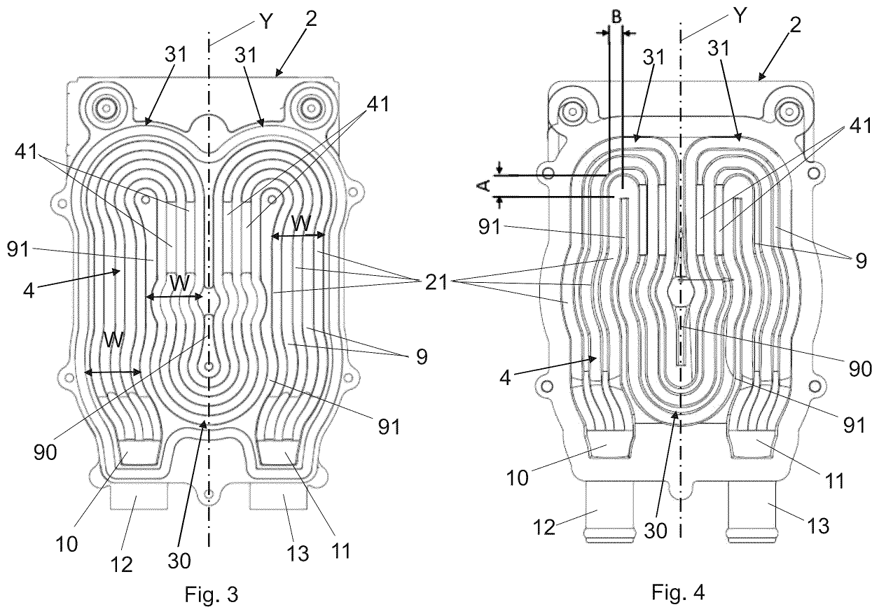

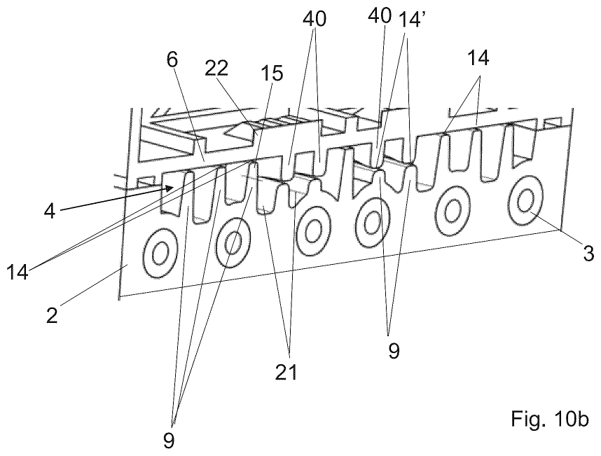

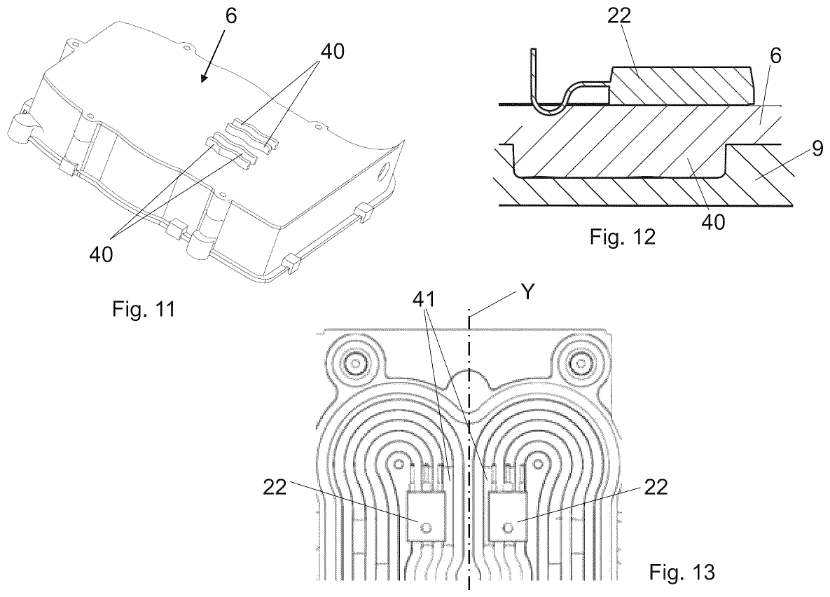

Advantageously, at least one longitudinal fin 40 is provided (FIGS. 10-12), projecting from the first side of said first cover 6 at said at least one electronic switch 22 and inserted into a corresponding longitudinal recess 41 (FIGS. 3-6), or longitudinal interruption, of at least one bulkhead 9 so that the longitudinal flanks of said at least one longitudinal fin 40 define part of a side wall of two adjacent channels 21 (FIG. 10). In other words, the longitudinal fin 40 of the cover 6, arranged at an electronic switch 22, is configured to locally replace a portion of bulkhead 9 delimiting two adjacent channels 21 of the flow path 4 of the liquid, said portion of bulkhead 9 corresponding to the space where the longitudinal recess 41, or longitudinal interruption, is provided.

In more detail, as illustrated for example in FIGS. 3-6 and 10a-12, each longitudinal fin 40 has a shape substantially complementary to the shape of the corresponding longitudinal recess 41, or longitudinal interruption, of the respective bulkhead 9 such as to keep the side wall of the two adjacent channels 21 substantially unaltered. This means that the longitudinal fin 40 occupies all of the free space of the longitudinal recess 41, or longitudinal interruption, of a corresponding bulkhead 9. In particular, the longitudinal extension of each longitudinal fin 40 is substantially equal to the longitudinal extension of a respective recess or longitudinal interruption 41 provided in a corresponding bulkhead 9.

With this configuration, the electronic switch is adequately cooled as the heat exchange surface below the switch increases, but the pressure losses do not increase because the flow of liquid remains substantially unaltered, in particular with respect to the flow of the liquid flowing in the channels where no longitudinal recess or longitudinal interruption in the bulkheads is provided. In other words, the insertion of each longitudinal fin 40 in the respective longitudinal recess 41 of the corresponding bulkhead 9 allows the side wall of two adjacent channels 21 to be entirely reconstructed.

Preferably, the at least one electronic switch 22 is arranged in a distal position both from the inlet section 10 and from the outlet section 11. Even more preferably, this position is a distal and median position between the inlet section 10 and the outlet section 11. In this way the flow direction can be reversed without jeopardizing the dispersion of heat of the electronic control unit that is cooled by a liquid which is at an intermediate compromise temperature between inlet and outlet. This allows the inlet and outlet ports of the heater to be connected arbitrarily to the relative hydraulic circuit, avoiding in any case the overheating of the electronic control unit.

In one variant, at least two electronic switches 22 are provided, preferably only two electronic switches, and at least one longitudinal fin 40 is provided at each electronic switch 22 and inserted into a respective longitudinal recess 41, or longitudinal interruption, of a corresponding bulkhead 9.

In a further variant, at least two longitudinal fins 40, preferably only two longitudinal fins, are provided at each electronic switch 22 and inserted into a respective longitudinal recess 41, or longitudinal interruption, of at least one corresponding bulkhead 9, for example of a single bulkhead 9, or of at least two corresponding bulkheads 9, for example of two corresponding bulkheads 9 (FIGS. 10a, 10b, 11 and 13).

In all these variants, the longitudinal fin or the longitudinal fins 40 can be smooth along the longitudinal flanks, or corrugated along said longitudinal flanks, for locally inducing a light turbulence and for increasing the heat exchange between electronic switches 22 and liquid.

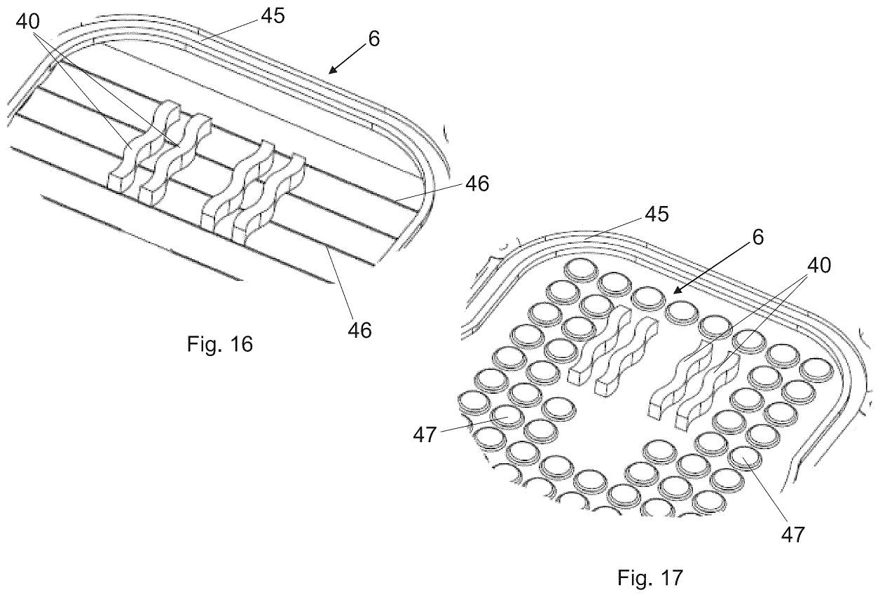

To further increase the dissipation of the heat generated by the electronic control unit it is possible to provide, in addition to the longitudinal fin or the longitudinal fins 40, linear projections 46, preferably but not necessarily parallel to each other, spaced apart by dips (FIG. 16), or projecting pins 47 (FIG. 17) on all or part of the inner surface of the cover 6, i.e. of the aforesaid first side of the cover 6, in contact with the liquid. Preferably, the body 2 is a block of die-cast metal material, e.g. aluminum or another suitable material, having a substantially flat shape with two major dimensions (length and width), preferably at least double the third dimension (thickness).

In a first embodiment (FIG. 10b) of the heater of the invention, only the flow path 4 is provided, at a first face of the body 2.

The cover 6 preferably rests in the compression area of a respective sealing gasket on the outer perimeter, respectively, of the first face of the body 2. The cover 6 is thus a component separated from the heating body 2, being connected to the latter, for example, with screws and gaskets.

The at least one electric resistor 3 is at least partly incorporated into the body 2, or (alternative not shown) it is arranged in contact on a second face of the body 2, opposite the first face.

Advantageously, there are provided:
a first gap 14 between the end edge 15 of the bulkheads 9 that are intermediate to the channels 21 and the cover 6;
and preferably a second gap 14′ between the longitudinal fin, or the longitudinal fins 40, and the corresponding longitudinal recess 41 or longitudinal interruption of the respective bulkhead 9.

Therefore, the channels 21 of the first flow path 4 are transversely communicating at the first gaps 14 and the possible second gaps 14′.

Preferably, the gap 14 and the possible gap 14′ are comprised in a range from 0.01 to 0.4 mm.

Optionally, the end edge of the bulkheads 9 and/or of said at least one longitudinal fin 40 and/or of said longitudinal recess 41 is a rounded edge.

The flow of liquid entering into the heater is diverted into the inlet section 10 in the flow path 4 and mainly proceeds into the channels 21, following the shape of the bulkheads. However, because of the gaps between the vertices of the bulkheads and the cover 6, the channels 21 are not hermetically separated and a secondary flow is created transverse to the channels 21, i.e. a secondary bypass flow between the inlet section and the outlet section. Therefore, the channels 21 substantially parallel to one another are not connected in parallel between the inlet section and the outlet section as there is always a transverse flow from one channel to the other.

The advantages of providing this gap are multiple:
avoiding a hyperstatic resting of the cover 6 on the first face of the body 2, and thus avoiding tensioning in assembly between the parts, considering that the parts have planarity errors;
avoiding an extended thermal contact between body 2 and cover 6 onto which the electronic control unit 8 is fastened, so as to reduce to a maximum any transfer of heat from the bulkheads to the electronic control unit; for this purpose, the end edge or tip of the bulkheads can also be rounded to minimize the transfer of heat in any accidental contact points;
promoting the upwards movement of the bubbles due to the effect of the force of relative gravity, preventing any air bubbles in the liquid from stagnating inside the channels, in particular if the flow is slow.

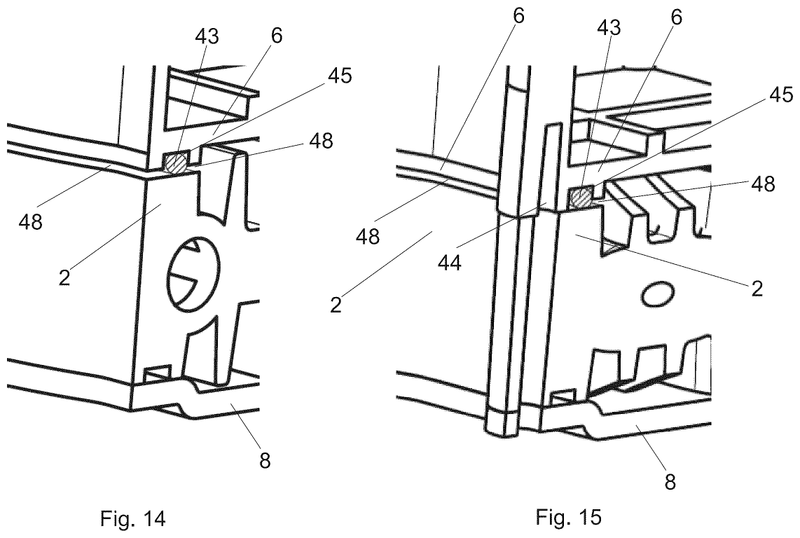

In a further variant illustrated in FIG. 14-15, to further reduce the transfer of heat from the heating body 2 to the cover 6 which also accommodates the electronic control unit, a further gap 48 between body 2 and cover 6 is conveniently provided also in the perimeter area in proximity to the sealing gasket 43, arranged in said perimeter area to prevent the leakage of liquid from the respective flow path towards the outside of the heater.

The sealing gasket 43 is arranged in a perimeter housing 45 made on the respective cover and/or on the respective face of the body 2.

The further gap 48 is provided on both the inner and outer sides of said perimeter housing 45 (FIG. 14), except preferably on the outer side at the outer housings 44 of fastening screws (FIG. 15), which fasten both covers 6, 7, and the body 2 arranged between them, to one another.

In a preferred variant of the heater of the invention the following features are also provided:
the at least one electrical resistor 3 is at least partially incorporated along a first plane X of the body 2 (FIGS. 2, 7-10b);
the inlet section 10 and the outlet section 11 are both arranged on a same side of the heater (FIGS. 3-6);
the first face of the body 2 is arranged at a first side of the first plane X;
the first flow path 4, which includes the inlet section 10 and the outlet section 11, is provided with an odd number of hairpin bends, preferably but not necessarily only three hairpin bends 30, 31, and is arranged symmetrically with respect to a second plane Y of the body 2 perpendicular to said first plane X.

A preferred variant of the heater of the invention provides that the at least one electronic switch 22 is arranged in proximity to the second plane Y, in a position equally distal both from the inlet section 10 and from the outlet section 11.

In other variants, the following can be provided:
an even number of electronic switches 22 arranged symmetrically with respect to the second plane Y,
or an odd number of electronic switches, arranged symmetrically with respect to the second plane Y, also possibly only one electronic switch.

In the example of FIGS. 3-6 and 13, two electronic switches 22 are provided arranged symmetrically with respect to the second plane Y, and the distance between one switch and the inlet section 10 is equal to the distance between the other switch and the outlet section 11.

In a second preferred embodiment of the heater of the invention (FIGS. 2 and 10a), in addition to what is described for the first embodiment, a second flow path 5 is also provided for the liquid, from said inlet section 10 to said outlet section 11, made on a second face of the body 2 arranged at a second side of the first plane X, opposite the first side. In other words, as can be seen in FIGS. 2 and 10a, the first face of the body 2 is arranged on a first side of the first plane X whereas the second face of said body 2 is arranged on a second side of said first plane X opposite the first side.

Also, this second flow path 5 is preferably provided with an odd number of hairpin bends, preferably but not necessarily only three hairpin bends 30, 31, and comprises a plurality of channels 21 branching off from the inlet section 10 and flowing into the outlet section 11, said channels 21 of the second flow path 5 being delimited by respective bulkheads 9 projecting from the second face of the body 2. This allows the compactness of the solution of the invention to be improved and simultaneously increasing the heat exchange between body 2 and liquid.

Also, the bulkheads 9, and thus the channels 21, of the second flow path 5, can be made by mechanically processing the second face of the body 2 or be directly made by die-casting, by producing a respective hollow area from which the bulkheads project.

The presence of the bulkheads 9 on both faces of the body 2 improves the removal of heat by increasing the effective heat exchange surface, at the same time reducing the wall temperature of the channels without the need to increase the overall dimensions and without the need for discontinuities in the flow and, therefore, higher pressure losses.

With these two flow paths 4, 5 on opposite faces of the body 2, vehicle manufacturers can use the heater of the invention with any orientation within vehicle platforms, as the heater will always have at least one face of the exchanger body that has an orientation of the heat exchange surface favorable to the possibility of removing the air and/or vapor that can form at the solid/liquid interface. Further, this allows for more reliable operation under typical vehicle use conditions, which involve variability in the direction of the gravitational force relative to the heater due to longitudinal and transverse slopes of the road path, as well as inertial forces caused by braking or direction change accelerations.

Advantageously, the first flow path 4 and the second flow path 5, which include in common both the inlet section 10 and the outlet section 11, can be symmetrically arranged both with respect to the first plane X and with respect to a second plane Y of the body 2 perpendicular to said first plane X. In particular, the first flow path 4 and the second flow path 5 are arranged symmetrically to each other with respect to the first plane X; and each flow path 4, 5 is also symmetrical with respect to the second plane Y. Therefore, the first path X of the body 2 is a plane of symmetry of at least one portion of the body 2 which comprises the first flow path 4 and the second flow path 5. In fact, the plane X divides said at least one portion of the body 2 into two parts which correspond in a planar symmetry of plane X. This configuration of the liquid circuit inside the heater of the invention allows vehicle manufacturers to use the heater of the invention in all vehicle platforms with the freedom to connect the inlet and outlet ports of the heater arbitrarily, freely reversing the flow direction.

The first plane X and second plane Y can be median planes of the body 2.

In this second embodiment 1, there is provided a second cover 7 which closes with its first side the second flow path 5.

The covers 6, 7 preferably rest in the compression area of a respective sealing gasket on the outer perimeter, respectively, of the first face and of the second face of the body 2. The covers 6, 7 are thus separate components from the heating body 2, being connected to the latter, for example, with screws and gaskets. Preferably, the covers 6, 7 are arranged parallel to each other and to the plane X.

Preferably, also in the second flow path 5, a gap 42 is provided (FIG. 10a) between the end edge 15 of the bulkheads 9 and the second cover 7, whereby mutually adjacent channels 21 are communicating at the gap 42. Therefore, the flow of liquid entering into the heater is diverted into the inlet section 10 in the flow paths 4, 5 and mainly proceeds in the direction of the channels 21, following the shape of the bulkheads. However, because of the gaps between the vertices of the bulkheads and the respective cover 6, 7, the channels 21 are not hermetically separated and a secondary flow is created transverse to the channels 21, i.e. a secondary bypass flow between the inlet section and the outlet section. Therefore, the channels 21 substantially parallel to one another are not connected in parallel between the inlet section and the outlet section as there is always a transverse flow from one channel to the other.

In all the embodiments of the heater of the invention, each channel 21 has a width of about 3-6 mm and a height of about 7-12 mm. Therefore, the small height of the bulkhead 9 increases the heat exchange efficiency thereof.

By way of non-limiting example, as shown in FIGS. 3-6, each flow path 4, 5, comprises three channels 21 and two intermediate bulkheads 9. FIGS. 3-6 illustrate only the first flow path 4 provided on the first face of the body 2. On the opposite and underlying side, i.e. on the second face of the body 2, the second flow path 5 can be provided.

In a preferred configuration, both for the first flow path 4 and for the possible second flow path 5, an intermediate hairpin bend 30 of said three hairpin bends is arranged at the second plane Y and proximal to the side of the heater where the inlet section 10 and the outlet section 11 are arranged; while two side hairpin bends 31 of said three hairpin bends are arranged symmetrically with respect to said second plane Y and distal from said side of the heater where the inlet section 10 and the outlet section 11 are arranged. Therefore, the first flow path 4 and the possible second flow path 5, and thus the respective channels 21, have a substantially capital M shape, with the side legs of the M shape at the inlet section 10 and the outlet section 11, respectively.

This M shape of each flow path 4, 5 is defined by further bulkheads 90, 91 formed on the respective face of the body 2. In particular, two side bulkheads 91 are arranged symmetrically with respect to the second plane Y and branch off from the side of the body 2 where the inlet section 10 and the outlet section 11 are arranged; whereas a central bulkhead 90 is arranged along said second plane Y and branches off from the side of the body 2 opposite the one where the inlet section 10 and the outlet section 11 are arranged.

Optionally, in the stretches that connect the inlet section 10 to the proximal side hairpin bend 31, the outlet section 11 to the proximal side hairpin bend 31, and the hairpin bends 31 to the intermediate hairpin bend 30, respectively, the bulkheads 9, 90, 91, and therefore the respective channels 21, have at least one undulated portion for producing a minimal turbulence in the liquid.

A gap can be provided between the end edge of the further bulkheads 90, 91 and the respective covers 6, 7.

In a variant, also the end edge of the bulkheads 90, 91 is a rounded edge.

Preferably, in all the embodiments of the heater of the invention, the following is provided:
a first port or pipe connection 12, projecting from the body 2 and communicating with the inlet section 10;
and a second port or pipe connection 13, projecting from the body 2 and communicating with the outlet section 11.

The first port 12 and second port 13 can be arranged symmetrically with respect to the second plane Y.

Advantageously, the ratio between the width W of the first flow path 4 and of the possible second flow path 5, and the inner diameter of the first port 12 and of the second port 13 is in a range from 1 to 2, preferably from 1.2 to 1.6. This ratio allows the liquid not to undergo strong speed variations at the inlet and outlet of the heater, which would increase pressure losses and imply the risk of overheating in possible recirculation zones.

The width W, indicated for example in FIG. 3, is the width of the flow path which includes the width of the channels 21 of said path and the thickness of the intermediate bulkheads 9 between said channels 21. In the example of the Figures, the width of the flow path consists of the width of the three channels 21 and the thickness of the two intermediate bullheads 9. In all the embodiments of the heater of the invention, each flow path 4, 5 can be produced according to different variants.

A first embodiment of the flow path, illustrated in FIG. 3, provides that the three hairpin bends 30, 31 are bends with an angle at the center greater than 180°, preferably greater than 180° and less than 220°.

In the non-limiting example of FIG. 3, the intermediate hairpin bend 30 has an angle at the center of about 190-200°; whereas the two side hairpin bends 31 have an angle at the center of about 200-220°.

In this embodiment, the channels 21 have the most uniform section as possible and the three hairpin bends 30, 31 are rounded to further reduce the pressure losses. Heat exchange is promoted by the heat exchange surface increase obtained through the bulkheads and not by the shape of the bends 30, 31.

A second embodiment of the flow path, illustrated in FIG. 4, provides that the three hairpin bends 30, 31 are bends with an angle at the center of about 180°; and wherein at least one channel 21, preferably the most internal channel, has, at the two side hairpin bends 31, a width A, measured parallel to the second plane Y, which is greater than the width B of the channel itself, measured perpendicularly to said second plane Y.

This second embodiment allows the weight and producibility of the body 2 to be optimized. Compared to the first embodiment, the hairpin bends are less rounded; however, to reduce turbulence and pressure losses the width of at least one channel 21 at the side hairpin bends 31 is increased (A>B), so that the fluid slows at the bend and generates less turbulence.

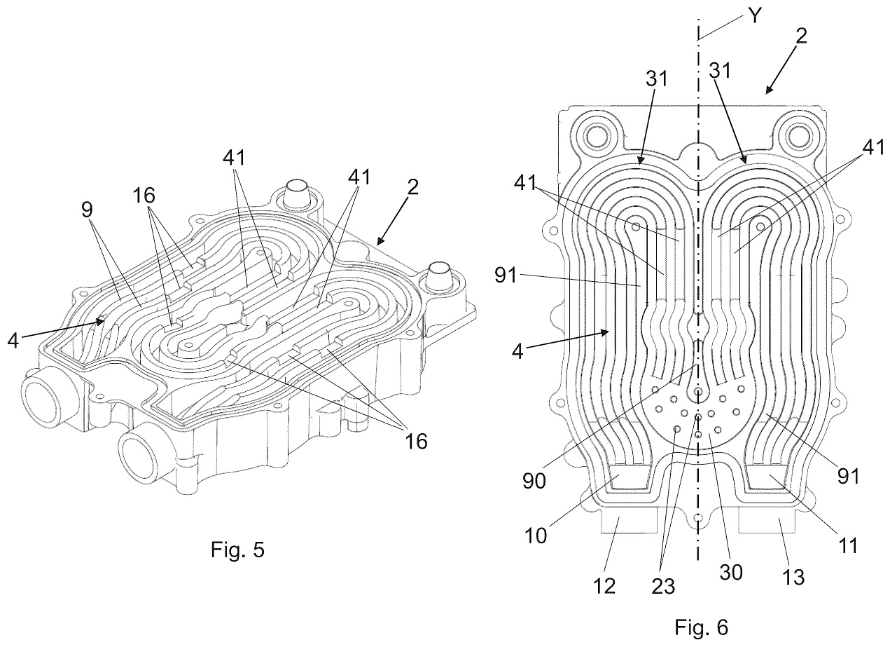

A third embodiment of the flow path, illustrated in FIG. 5, provides that the bulkheads 9, in particular the intermediate bulkheads between one channel 21 and the adjacent one, are provided with at least a respective recess 16 at the end edge 15. Preferably, but not necessarily, the recesses 16 are arranged symmetrically with respect to the median plane Y. In FIG. 5 the number of recesses 16 is equal to six, but their number can be greater or less than 6.

The depth of said recesses 16 is preferably comprised between 0.2 and 3 mm, preferably between 1 and 3 mm.

These recesses 16 further promote the aforesaid transverse flow between the channels 21. By varying their number and position, a predetermined design value of flow transversal to the channels can be defined.

A fourth embodiment of the flow path, illustrated in FIG. 6, provides that at least some bulkheads 9, in particular the intermediate bulkheads between one channel 21 and the adjacent one, are completely interrupted at the intermediate or central hairpin bend 30, and a plurality of protrusions 23 are provided in said intermediate hairpin bend 30.

The protrusions 23 can be in the form of pegs of various possible shapes (circular, oval, rectangular section, etc.), adapted to increase the heat exchange surface locally. In fact, it is possible that at least one electrical resistor 3 has at the central hairpin bends 30 a greater concentration of power. The local increase in heat exchange is obtained by replacing the flow path with substantially M-shaped channels with a flow path with two U-shaped channel stretches, also defined by the bulkheads 91 and connected in sequence from an intermediate curved area from which the pegs 23 project and in which the flow of the channels joins completely.

FIGS. 5 and 6 illustrate the features described for the third and fourth embodiments of the flow path in combination with the features described above of the first embodiment of the flow path. Alternatively, it is possible to combine the features described for the third and fourth embodiment with the features described above for the second embodiment.

In all embodiments of the heater of the invention, preferably the at least one electrical resistor 3 is a tubular resistor partially incorporated along the first plane X of the body 2.

In particular, the heating part of said at least one electrical resistor 3 is completely incorporated into the body 2 along said first plane X.

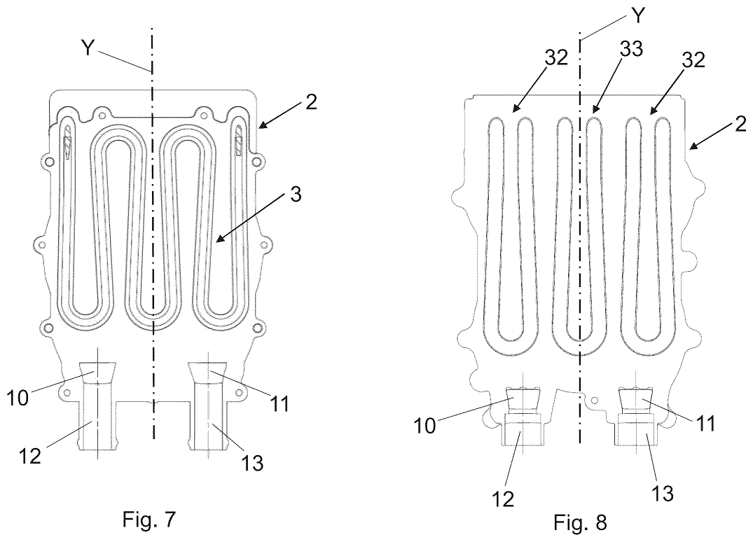

FIG. 7 illustrates a first variant wherein only one tubular serpentine resistor 3 is provided, preferably arranged symmetrically with respect to the second plane Y.

FIG. 8 illustrates a second variant wherein at least three tubular resistors 33, 32 are provided, which can be electrically connected in series or in parallel; preferably wherein the assembly of said at least three tubular resistors is symmetrically arranged with respect to the second plane Y.

In all the variants the single resistor 3 or all the resistors 33, 32 are arranged exclusively along the first plane X, partially incorporated into a single body 2.

1. An electric heater for a vehicle, adapted to heat a liquid crossing said heater, comprising
a body made of die-cast metal material;
at least one electrical resistor in contact with said body;
an inlet section and an outlet section for the liquid;
a first flow path for the liquid, from the inlet section to the outlet section made on a first face of said body;
a first cover which closes with a first side thereof the first flow path;
an electronic control unit arranged on a second side of said first cover, opposite the first side;
wherein the first flow path comprises a plurality of channels which branch off from the inlet section and flow into the outlet section and which are delimited by bulkheads projecting from the first face of the body;
wherein said electronic control unit comprises at least one electronic switch;
and wherein at least one longitudinal fin is provided, projecting from the first side of said first cover at said at least one electronic switch and inserted into a corresponding longitudinal recess or longitudinal interruption of a respective bulkhead, and wherein longitudinal flanks of said at least one longitudinal fin define part of a side wall of two adjacent channels of said plurality of channels.

2. The heater according to claim 1, wherein said at least one longitudinal fin is configured to locally replace a portion of a respective bulkhead delimiting two adjacent channels of said plurality of channels.

3. The heater according to claim 1, wherein said at least one longitudinal fin has a shape substantially complementary to a shape of the corresponding longitudinal recess, or longitudinal interruption, of the respective bulkhead such as to keep the side wall of the two adjacent channels substantially unaltered.

4. The heater according to claim 1, wherein said at least one electronic switch is arranged in a position distal both from the inlet section and from the outlet section, in a median position between said inlet section and said outlet section.

5. The heater according to claim 4, wherein at least two electronic switches are provided, and at least one longitudinal fin is provided at each electronic switch and inserted into a respective longitudinal recess or longitudinal interruption of a corresponding bulkhead; wherein at least two longitudinal fins are provided at each electronic switch and inserted into a respective longitudinal recess or longitudinal interruption of at least one corresponding bulkhead or at least two corresponding bulkheads.

6. The heater according to claim 1, wherein said at least one longitudinal fin is smooth or corrugated along the longitudinal flanks.

7. The heater according to claim 1, wherein there are provided
a first gap (14) between an end edge of the bulkheads and the first cover;
and a second gap between the longitudinal fin, or the longitudinal fins and the corresponding longitudinal recess or longitudinal interruption of the respective bulkhead;
whereby mutually adjacent channels are communicating at the first gap and the second gap.

8. The heater according to claim 7, wherein the end edge of the bulkheads and/or of said at least one longitudinal fin and/or of said longitudinal recess is a rounded edge.

9. The heater according to claim 1, wherein a sealing gasket is provided, arranged in a perimeter housing made on the first cover and/or on the first face of the body and wherein a gap is provided between the body and the first cover at said perimeter housing.

10. The heater according to claim 1, wherein
said at least one electrical resistor is at least partially incorporated along a first plane of said body;
the inlet section and the outlet section are both arranged on a same side of the heater;
the first face of said body is arranged at a first side of said first plane;
the first flow path which includes said inlet section and said outlet section is provided with an odd number of hairpin bends, three hairpin bends and is arranged symmetrically with respect to a second plane of the body perpendicular to said first plane.

11. The heater according to claim 10, wherein in the first flow path an intermediate hairpin bend of said three hairpin bends is arranged at the second plane and proximal to the side of the heater where the inlet section and the outlet section are arranged; while two side hairpin bends of said three hairpin bends are arranged symmetrically with respect to said second plane and distal from said side of the heater.

12. The heater according to claim 10, wherein there is provided a second flow path for the liquid, from said inlet section to said outlet section, made on a second face of said body arranged at a second side of said first plane opposite the first side;
wherein also the second flow path is provided with an odd number of hairpin bends, three hairpin bends, and comprises a plurality of channels which branch off from the inlet section and flow into the outlet section;
wherein the channels of the second flow path are delimited by respective bulkheads projecting from the second face of the body;
and wherein the first flow path and the second flow path, which include said inlet section and said outlet section are arranged symmetrically both with respect to said first plane and with respect to said second plane.

13. The heater according to claim 10, wherein said at least one electronic switch is arranged in proximity to said second plane; wherein an even number of electronic switches is provided, arranged symmetrically with respect to said second plane or wherein an odd number of electronic switches is provided, arranged symmetrically with respect to said second plane, wherein only one electronic switch is provided.

14. The heater according to claim 12, wherein a second cover is provided which closes with a first side thereof the second flow path.

15. The heater according to claim 14, wherein in the second flow path a gap is provided between the end edge of the bulkheads and the second cover, whereby mutually adjacent channels are communicating at the gap.

16. The heater according to claim 12, wherein, both for the first flow path and for the second flow path, an intermediate hairpin bend of said three hairpin bends is arranged at the second plane and proximal to the side of the heater where the inlet section and the outlet section are arranged; while two side hairpin bends of said three hairpin bends are arranged symmetrically with respect to said second plane and distal from said side of the heater.

17. The heater according to claim 7, wherein at least some bulkheads are provided with at least one respective further recess at the end edge for a greater transverse communication between adjacent channels.

18. The heater according to claim 10, wherein at least some bulkheads are interrupted at the intermediate hairpin bend, and a plurality of projections are provided in said intermediate hairpin bend.

19. The heater according to claim 10, wherein the three hairpin bends are bends with an angle at the center greater than 180°, preferably greater than 180° and less than 220°;
or wherein the three hairpin bends are bends with an angle at the center of about 180°.

20. The heater according to claim 16, wherein the three hairpin bends (30, 31) are bends with an angle at the center of about 180°; and wherein at least one channel (21) has, at the two side hairpin bends (31), a width A, measured parallel to the second plane (Y), which is greater than a width B of the channel itself, measured perpendicularly to said second plane (Y).

21. (canceled)
